(19) United States
(12) Patent Application Publication
(10) Pub. No.: US 2005/0086529 A1
(43) Pub. Date: Apr. 21, 2005

(54) Detection of misuse or abuse of data by authorized access to database

(76) Inventor: Yair Buchsbaum, Givataim (IL)

Correspondence Address: YAIR BUCHSBAUM, 4, HAMALOT ST., GIVATAIM, 53258, IL

(21) Appl. No.: 10/689,113

(22) Filed: Oct. 21, 2003

(51) Int. Cl. G06F 11/30

(52) U.S. Cl. 713/201; 707/9

(57) ABSTRACT

The present invention relates to a system for detecting misuse and/or abuse of data related to database done by a user with authorized access to a data system and its database. User behavior is monitored as to its nature of database access, analyzed to create, and compare to, a specific profile. No understanding for the meaning of data content is needed. Each deviation from normal pattern, stored in the profile, is checked in various parameters and ranked, reporting to a system owner.

### BACKGROUND OF THE INVENTION

1. Field of the Invention

The present invention relates to a method and system for detecting misuse and/or abuse of data related to database caused by a user with authorized access to a data system. Even more specifically, the present invention relates to a method and system automatically recognizing, with highly reliability, data misuse and/or abuse that minimizes creation of false positive warnings or alarms, eliminates the need for programmers to enter rules or the need to build lexicon or any other need for manually predefined terms or situations, and permit handling of mass transactions resulting from mass quantity of users with minimum overhead to the operational system.

2. Discussion of the Related Art

As used herein, misuse or abuse are defined as use of a data, from data gathering system, by an authorized user which is permitted by the system but which is uncharacteristic, violates an internal security policy, or is otherwise out of the bounds or deemed inappropriate of the intended use of its authorization or of the system.

Misuse will be distinguished from intrusion, which is prohibited behavior such as the deliberate attempt to disrupt system operations or gain access to system areas which are prohibited from access by the user. These intrusions are generally performed by people who are unauthorized, or are outsiders from an organization, and wish to remain unidentified. The results of intrusions may be catastrophic and therefore a great deal of development has been done in the intrusion prevention and detection area.

The most valuable asset of a data gathering system or a computerized system is its database. Database, in all forms and structures, holds the data related to systems and to an entity business or operation. Many researchers proofs that substantial entities' damages are a result of inappropriate acts done by authorized users. Damages can have the form of direct financial lost, proprietary information lost or exposed, violating privacy commitments and exposing competitive secrets.

Databases are being modified by: writing, deleting or updating data, and querying, to achieve desired specific data stored within the database. All those operations are subject to authorization given to users, according to a security policy, in order to allow users to fulfill their legitimate and predefined jobs and tasks.

What is needed in the art is a system whereby misuse and/or abuse, or potential misuse and/or abuse, of the data by authorized users, or authorized user terminals, may be flagged and if necessary, reported, without undue interference or restriction to the user or system. Such misuse detection should be reliable, unobtrusive and should not require a large amount of processing overhead or resources when possible.

Definitions

“Data” refers herein to any form of stored information, unless otherwise limited or defined by the context of the disclosure.

“Alarm” or “Warning” means reporting a potential misuse and/or abuse.

“Database” means a logically, independently operating data storage, search, retrieval, and manipulation system.

“Profile's parameters” means any figures or terms representing behavior and/or occurrence of database access. e.g., commonly used statistics terms and/or any other figure or term, representing behavior and/or occurrence over any timeframe, referring to a combination of, part or all: user identification, terminal and/or port identification and characteristics of database access.

“Characteristics of database access” means any information related to a database access. This information may include: nature of operation (e.g. add, write, read etc.), database desired section (e.g. table, scheme, record, cluster etc.), timestamp, desired machine and so forth.

Discussion of the modules or application routines herein will be given with respect to specific functional tasks or task groupings that are in some cases arbitrarily assigned to the specific modules for explanatory purposes. It will be appreciated by the person having ordinary skill in the art that a misuse detector according to the present invention may be arranged in a variety of ways, and implemented with software, firmware, or hardware, or combinations thereof, and that functional tasks may be grouped according to other nomenclature or architecture than is used herein without doing violence to the spirit of the present invention.

### SUMMARY OF THE INVENTION

The present invention answers the above-described need for misuse and/or abuse detection. The embodiments herein will be presented in terms of particular information retrieval systems although the invention is not necessarily intended to be so limited. The present invention is fundamentally different from intrusion, or attack, detection because it is concerned with user behavior which is permitted by a data gathering system but which may be deemed inappropriate. The present invention is fundamentally different because intrusion detection or prevention is usually based on tracking operating system or networking system performance, this invention is focusing on database. The present invention is fundamentally different from other suggested human behavior tracing systems, as it need not understand the actual meaning of the data processed or manipulated by the user. The present invention is not concerned with computer operating systems or networks but is concerned with user behavior and operations at the database transactions level. Thus, intrusion detection and/or prevention systems, as well as fraud detection system or any other system analyzing context of data, and the present invention for misuse and/or abuse detection are not mutually exclusive and may be used together.

The present invention is also fundamentally different because the misuse and/or abuse detection system works from gathering and maintaining knowledge of the behavior of an authorized user, rather than anticipating attacks by unknown assailants. Thus, the present invention is adapted to build and maintain a profile of the behavior of a user, and/or terminal, with respect to its operations toward databases, through tracking, or monitoring, of user activity within the database system and to compare each new use of the system by the user to a known profile.

There are essentially, but not limited to, two data sources that serve as foundation to the operation described in this invention. Both are included within any database mechanism or can be built for those purposes. The first is a log, trace or alike, file that contains definition and identification of a user and/or terminal and process allocation. The user identification within the system is needed to assure proper data exchange to/from a specific user. The second is a trace file, or alike, that contains all access transactions (orders) routed to a database, including the user identification. Those transactions details, characteristics of database access, include all possible different access or requests from a database, e.g. query, add, delete, update.

A user's, or terminal, information profile will show, after a learning period, certain consistencies in user activity toward a database. Based on a profile constructed by the present system, new activity will be compared to the profile and be rated by the present system, to cause the system to flag anomalous user behavior and, when necessary, to issue an alarm that potential misuse or abuse is indicated.

Accordingly, a set of algorithms, or techniques, were developed to build a user profile and detect anomalies in user behavior compared against the user's profile which will indicate potential misuse or abuse of the data system. Each algorithm may independently flag certain anomalies. Together, the algorithms may be used to increase the likelihood of detecting a misuse or abuse.

Profile Structure

Knowledge of a user's, or terminal, activities toward database of an information retrieval system is added to a profile in the form of indices according to, but not limited to,—nature of operation; time and date stamp; user ID; terminal ID; targeted data section within the database.

The above information is gathered and become subject to set of operations, or algorithms, constructing variety of characteristics, statistically or other, for a specific user and/or terminal. A sample of those characteristics is: average quantity of database accesses—per hour, per day, per month, per year, per a specific day of a week, per a specific day of a month, per a specific timeframe of a day, etc. The same can be done whilst sorting and filtering the above data according to different data sections within the targeted database (e.g. name of table, scheme, record, cluster). To enhance detection precision, an algorithm calculating the standard deviation, or any predefined and/or acceptable deviation formula, is applied, for the same, or alike, characteristics.

In order to increase the system's accuracy, the same data manipulation is being done for groups of people (or working stations); each group contains people with same or similar job tasks, position, or operations environment.

After a learning period, which can vary in time according to the inspected information retrieval system's size and complexity, a stable profile is being defined. Any new data representing user and/or terminal access to database, as described above, need to be checked against the appropriate profile, in all its levels and parameters. Any deviation is subject to further investigation. Each deviation is graded according to its level of deviation from one or several parameters. An algorithm calculates the results of all related comparisons and according to predefined scale of severity, produces a warning or, if a threshold is being crossed, an alarm—both with weighted grade.

A system owner has the option to mark certain section within the database or specific user/s and/or terminal/s, as needing special observation. This action will set a desire sensitivity level and will be added to the prior discussed algorithm and calculations determining the grade of a deviation.

Any deviation, whether ignored, warned or alarmed, might be used to update user or terminal profile, after being investigated and approved by the system owner.

Entity Data Integration

Entity data integration is a technique whereby data sources providing information on the user or terminal are integrated into the misuse and/or abuse detection system. For example, a vacation schedule database may be utilized to flag any data activity performed by a user when the vacation schedule indicates that the user should be inactive.

Also, the entity data sources can be used to group users, for the detection system purposes as described above, according to their position within the entity's hierarchical structure.

Each of the techniques described above may be used singly or in various combinations. For example, an alarm might not be presented until each of the three techniques has indicated, or flagged, a potential misuse and/or abuse. If combined, the techniques could also be weighted or scaled according to a relative importance for a given employee classification. Moreover, the discussed algorithms could be time-sensitive and/or dependable, i.e. deviation's intensity may increase as time passes and/or its occurrence repeated. The discussed system takes full advantage of the historical information that exists within the profile data and its continuous operation.

### BRIEF DESCRIPTION OF THE DRAWINGS

FIG. 1 shows an example of a possible implementation related to discussed invention, presenting typical parts of information retrieval system with a misuse or abuse detector of the present invention integrated therein.

FIG. 2 shows an example of a check process related to the misuse or abuse detector with a sample for grading anomaly database access.

### DETAILED DESCRIPTION OF THE PREFERRED EMBODIMENT

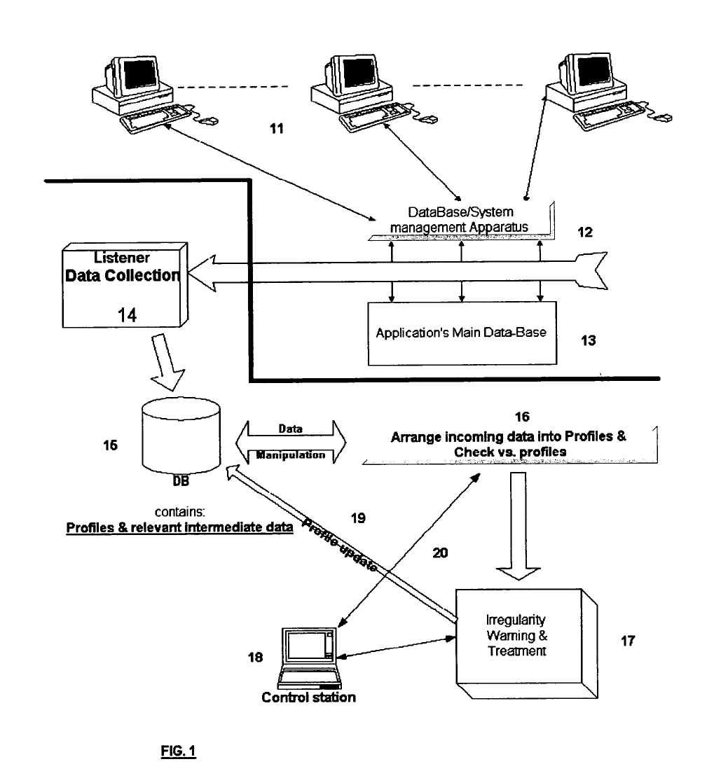

Referencing FIG. 1, a representative information retrieval system terminals/workstations (11) connected and/or referenced to a main database (13). A major element in a proper database operational system is a database & system management apparatus (12). This element main responsibility is queuing, tasks executing and data-traffic management between a user/terminal (11) and the database (13). A Listener (14), as a part of a system referred by present invention, collects, on continuous basis, data from the management apparatus' (12) data files. This raw data, containing details regarding terminal and/or user identification and database access requested, is stored in a separated database (15) for the usage of discussed system.

The main process of the system (16) represent the part which is responsible for: a. Constructing a user/terminal profile based on the raw data, collected by the listener (14) above and stored in this system database (15), and set of rules representing common statistics, mathematical or others techniques. Profiles are being constructed initially within a “learning period” and updated as described below. Profiles are stored in a different segment within the mentioned database area (15); b. Comparing each data trace of data access to the appropriate profile/s (its own user/terminal and/or group); c. Marking any anomaly, i.e. deviation from the values stored within the profile, found in the comparison phase and grading it according to an algorithm, using profile data and system owner instructions, such as levels of thresholds.

All warnings are being treated by the irregularity warning & treatment module (17), which put the emphasis on human interface, providing clear data presentation and investigation availability for better understanding. From a control station/console (18) a system owner receives warnings as for potential data misuse or abuse, based on deviation from a profile, as described above. The owner may decide on how often a report will be issued. Also, the owner can instruct the system to accept the suspected action as legitimate one and update the profile accordingly, for intermediate period or permanently (19). The system owner may change sensitivities, thresholds and so forth within the comparison phase parameters (20) via the control station (18) to achieve best-fitted system.

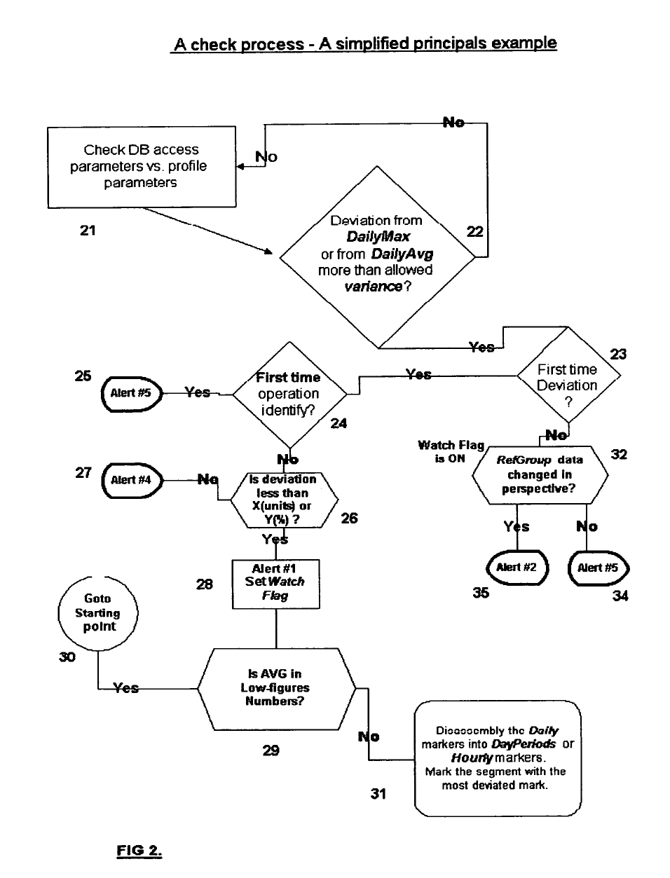

Referencing FIG. 2, for each database access, recorded and stores by a mechanism such as described in FIG. 1., above, a checking process (related to part 16 within FIG. 1.) is initiated (21) comparing the specific access parameters to an aggregative parameters that create the user/terminal profile.

The first check, in this limited example, is comparison the number of times the same access has been occurred at current day. A comparison (22) is being calculated against the known: maximum daily and daily average, values that have been set within the “learning period” and herein based on simple statistics. If values are within known limits, no action is taken, but the registration of that access to be updated relevant counters and other records to be used later, if needed. If a deviation from those limits is found, next check (23) asks if this is the first time the specific user/terminal is found out of range. This check may be using a special flag within user/terminal record (watch flag).

If this is indeed the first time a deviation has been noticed, more detailed checks are being performed. First (24) the nature of the operation is being checked. If this is the first time, ever, user/terminal is performing such an operation a warning (25) with highest grade will be produced. The reason for this is the fact that such an operation have never been recorded for that specific user/terminal, therefore, it is very likely that this anomaly behavior might represent a potential misuse of data. If the above is not the case, a further check is being executed (26), to assess the intensity of the deviation. A substantial deviation will produce (27) a warning with appropriate grade. A small deviation, as this is the first deviation recorded for the specific user/terminal, will only set a “watch flag” (28) to increase the sensitivity for next time check. A further, more detailed check (29+31) might be done, to assist in analyzing behavior, deviation and improving warning accuracy. The above checks can be repeated whilst referencing to daily time fractions, e.g. within each hour of the 24 hours a day, or within 4 major period of a working day (such as: morning, mid-day, afternoon, night) and so forth. If there is no need for that, or results do not show any added value, checking procedure is terminated (30) and starts all over with next record of database access.

If, on the other hand, this is not the first time a deviation was reported for that user/terminal, and “watch flag” was set previously, the procedure checks the parameters of the reference group profile (32). As described above, each user/terminal may be a part of a group performing similar, same or alike tasks or jobs. A profile is set to a group on similar basis as for user/terminal profile, but holds more general values representing whole group behavior pattern. A comparison check to the group parameters might change warning grade as if group parameters also changed, in same direction, with user/terminal (35) alert grade will be substantially lower than its grade when group data is not supporting user/terminal act (34).

Each of the techniques described above is an example only and can be modified, elaborated, enhanced in any way to fulfill the task of a misuse and/or abuse detector, as been defined in this invention. Each of those techniques may be used singly or in various combinations. For example, an alarm might not be presented until each of “n” techniques has indicated a potential misuse. If combined, the techniques could also be weighted or scaled according to a relative importance for a given employee or database segment classification.

Having thus described a misuse detector for monitoring user behavior to determine if misuse of authorized access to a data gathering system is occurring; it will be appreciated that many variations thereon will occur to the artisan of ordinary skill upon an understanding of the present invention, which is therefore to be limited only by the appended claims.

1. A method for identifying a misuse and/or abuse of authorized access to a database of a data gathering system by a user, comprising: a) constructing a user and/or terminal profile representing a pattern of database's accesses; b) monitoring user and/or terminal database access; c) comparing the monitored database access' information with existing profile to determine anomalies and/or irregularities; and d) identifying a potential misuse and/or abuse when an anomaly is detected.

2. The method for identifying a misuse and/or abuse of authorized access to a database of a data gathering system by a user according to claim 1, further comprising: a) comparing the anomalies to the user and/or terminal profile's parameters and grade it accordingly; b) reporting a potential misuse and/or abuse when the grade exceeds a predetermined threshold; and c) update profile according to comparison results and/or system owner instructions.

3. The method for identifying a misuse and/or abuse of authorized access to a database of a data gathering system by a user according to claim 2, further comprising: a) constructing a profile for a group of users and/or terminals, representing a pattern of database's accesses related to that group; b) comparing database access' parameters of a specific user and/or terminal with existing related group profile to determine anomalies and/or irregularities.

4. The method for identifying a misuse and/or abuse of authorized access to a database of a data gathering system by a user according to claim 1-3, wherein a) there is no need to understand and/or analyze the context of the actual data been manipulated and/or processed by a user; and b) the characteristics of each database access do not need to be predefined.

5. The method for identifying a misuse and/or abuse of authorized access to a database of a data gathering system by a user according to claim 1-3, wherein the parameters of a profile are: a) commonly used statistics terms and/or any mathematical model and/or other figure or term, representing behavior and/or occurrence over any timeframe; and b) combine, part or all of: user identification, terminal and/or port identification, key characteristics of a database access, time stamp of the access.

6. The method for identifying a misuse and/or abuse of authorized access to a database of a data gathering system by a user according to claim 1-3, wherein the parameters and/or the depth of a profile are flexible and subject to a system owner's decisions with respect to time frames and levels of database segments.

7. The method for identifying a misuse and/or abuse of authorized access to a database of a data gathering system by a user according to claim 1-3, wherein the related operations are executed in real-time, near real-time and/or on-line with the occurrence of database access, or off-line, batch mode and/or long after the actual access to database has been occurred.

8. The method for identifying a misuse and/or abuse of authorized access to a database of a data gathering system by a user according to claim 1-3, wherein the machines, servers and/or any related hardware of the data gathering system are singular or plural, distributed geographically and/or logically, and where database is singular or plural, distributed geographically and/or logically.

9. The method for identifying a misuse and/or abuse of authorized access to a database of a data gathering system by a user according to claim 1-3, wherein a) the system owner can indicate specific segment/s within a database to be more sensitive than others and/or with predefined weight, for each desired segment, to be calculated accordingly in grading a warning or alarm; and/or b) the system owner can indicate specific user/s and/or terminal/s to be monitored and referenced with more sensitivity than others and/or with predefined weight, for each desired user or terminal, to be calculated accordingly in grading a warning or alarm.
